(19) United States
(12) Patent Application Publication
(10) Pub. No.: US 2026/0025717 A1
(43) Pub. Date: Jan. 22, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Zhihong QIU, Shenzhen (CN); Mengjie ZHANG, Shenzhen (CN); He HUANG, Shenzhen (CN); Fei DONG, Shenzhen (CN); Sergio PAROLARI, Shenzhen (CN)

(73) Assignee: ZTE CORPORATION, Shenzhen, Guangdong, (CN)

(21) Appl. No.: 19/346,485

(22) Filed: Sep. 30, 2025

Related U.S. Application Data
(63) Continuation of application No. PCT/CN2023/087008, filed on Apr. 7, 2023.

(51) Int. Cl. H04W 36/00; H04W 72/044; H04W 72/21

(52) U.S. Cl. CPC H04W 36/00725; H04W 72/044; H04W 72/21

(57) ABSTRACT

A wireless communication method and/or apparatus is disclosed. The method comprises receiving, by a wireless communication terminal from a network node, configuration information for a handover procedure without a Random Access Channel, RACH procedure; initiating, by the wireless communication terminal, the handover procedure without a RACH procedure according to the configuration information; and transmitting, by the wireless communication terminal to a wireless communication node, uplink, UL, data for the handover procedure without a RACH procedure according to the configuration information.

### CROSS-REFERENCE TO RELATED PATENT APPLICATIONS

This application claims the benefit of priority under 35 U.S.C. § 120 as a continuation of International Patent Application No. PCT/CN2023/087008, filed on Apr. 7, 2023, the disclosure of which is incorporated herein by reference in its entirety.

### TECHNICAL FIELD

This document is directed generally to wireless communications, for example including 5th generation (5G) communications or 6th generation (6G) communications.

### BACKGROUND

Current NTN (non-terrestrial network) is based on a premise that the transmission delay between UE (user equipment) and satellites can be pre-compensated by a UE and/or a NW (network). The NW will broadcast assisting information (e.g., satellite ephemeris, common TA (time advance) relevant parameters, etc.) based on which the UE can derive the satellite's location (using satellite ephemeris), and the distance between satellite to UL synchronization reference point (RP) (using common TA parameters).

### SUMMARY

This document relates to methods, systems, and devices for wireless communication.

One aspect of the present disclosure relates to a wireless communication method. In an embodiment, the wireless communication method includes: receiving, by a wireless communication terminal from a network node, configuration information for a handover procedure without a Random Access Channel, RACH procedure; initiating, by the wireless communication terminal, the handover procedure without a RACH procedure according to the configuration information; and transmitting, by the wireless communication terminal to a wireless communication node, uplink, UL, data for the handover procedure without a RACH procedure according to the configuration information.

Another aspect of the present disclosure relates to a wireless communication method. In an embodiment, the wireless communication method includes: transmitting, by a network node to a wireless communication terminal, configuration information for a handover procedure without a Random Access Channel, RACH, procedure to allow the wireless communication terminal to initiate the handover procedure without a RACH procedure according to the configuration information and transmit uplink, UL, data for the handover procedure without a RACH procedure according to the configuration information.

Another aspect of the present disclosure relates to a wireless communication terminal. In an embodiment, the wireless communication terminal includes a communication unit and a processor. The processor is configured to: receive, via the communication unit from a network node, configuration information for a handover procedure without a Random Access Channel, RACH procedure; initiate the handover procedure without a RACH procedure according to the configuration information; and transmit, via the communication unit to a wireless communication node, uplink, UL, data for the handover procedure without a RACH procedure according to the configuration information.

Another aspect of the present disclosure relates to a wireless communication node. In an embodiment, the wireless communication node includes a communication unit and a processor. The processor is configured to: transmit, via the communication unit to a wireless communication terminal, configuration information for a handover procedure without a Random Access Channel, RACH, procedure to allow the wireless communication terminal to initiate the handover procedure without a RACH procedure according to the configuration information and transmit uplink, UL, data for the handover procedure without a RACH procedure according to the configuration information.

Various embodiments may implement the following features:

Preferably or in some embodiments, the configuration information comprises at least one of:
an indication indicating a RACH procedure being skipped in the handover procedure;
Timing Advance, TA, information indicating a target TA to be applied to the wireless communication terminal;
a UL grant resource configuration for a pre-allocated UL resource for a transmission of the UL data;
power control relevant information for a transmission of the UL data;
a configuration for the wireless communication terminal to perform a fallback to a handover procedure with a RACH procedure;
a Scheduling Request, SR, configuration;
a beam relevant configuration for beam training when UE is scheduled by dynamic grant;
a physical downlink control channel (PDCCH) configuration;
a physical uplink control channel (PUCCH) configuration; or
a RACH configuration for early TA compensation.

Preferably or in some embodiments, UL grant resource configuration comprises at least one of:
a code domain resource configuration;
a time domain resource configuration;
a frequency domain resource configuration;
a Subcarrier Spacing, SCS, configuration;
antenna port information;
information indicating that whether a transform precoding is used;
at least one of time domain resource or frequency domain resource to transmit hybrid automatic repeat request, HARQ, acknowledge information;
a channel status information, CSI, request;
a number of HARQ process numbers used for a Physical Uplink Shared Channel,
PUSCH, transmission;
information indicating whether a HARQ feedback is disabled;
information to determine HARQ type information;
beam information associated with a pre-allocated UL resource;
a validity duration for a configuration of a pre-allocated UL resource for a transmission of the UL data; or
a priority index associated to a pre-allocated UL resource.

Preferably or in some embodiments, the beam information comprises at least one of:
a beam type;
a beam index or a list of beam index;
a threshold for a beam selection for a PUSCH transmission;
a mapping relationship between a PUSCH resource and a selected beam;
a Sounding Reference Signal, SRS, resource indicator for a beam selection;
a mapping pattern for an SRS resource;
a Transmission Configuration Indication, TCI, state configuration;
bandwidth part, BWP, information for a pre-allocated UL resource for a transmission of the UL data; or
UL carrier information for a pre-allocated UL resource for a transmission of the UL data.

Preferably or in some embodiments, the power control relevant information comprises at least one of:
a target power level for a transmission of the UL data;
a delta power level used in a transmission power calculation;
a RACH type; or
an alpha value for a transmission power calculation of a transmission of the UL data.

Preferably or in some embodiments, the configuration for the wireless communication terminal to perform a fallback to a handover procedure with a RACH procedure comprises a configuration of a timer, wherein the wireless communication terminal performs at least one of:
in response to an expiry of the timer, initiating a RACH procedure in a target cell;
in response to an expiry of the timer, releasing a pre-allocated UL resource;
in response to an expiry of the timer, keeping a pre-allocated UL resource; or
upon initiating a RACH procedure, using a Cell Radio Network Temporary Identifier, C-RNTI, to monitor physical downlink control channels, PDCCHs.

Preferably or in some embodiments, the SR configuration comprises at least one of:
an indication indicating whether an SR can be initiated when there is no available UL resource; or
a dedicated SR configuration;

Preferably or in some embodiments, the wireless communication terminal performs at least one of:
using a dedicated SR resource for sending an SR;
selecting randomly among the available SR resources for sending an SR;
selecting a latest SR resource among available SR resources for sending an SR; or
selecting an SR with a highest priority when a request resource is for a Common Control Channel, CCCH, message.

Preferably or in some embodiments, the wireless communication terminal performs at least one of:
determining a UL resource among candidate UL resources which are pre-allocated or dynamically scheduled to transmit the UL data; or
determining a beam to transmit the UL data.

Preferably or in some embodiments, the wireless communication terminal performs at least one of:
selecting a beam satisfying at least one of the conditions below as the beam to transmit the UL data:
the beam is associated with a Synchronization Signal/Physical Broadcast Channel Block, SSB, with a reference signal received powers, RSRP, higher than or equal to a first configured threshold; or
the beam is associated with a channel status information reference signal, CSI-RS, with a RSRP higher than or equal to a second configured threshold;
selecting any available beam as the beam to transmit the UL data in response to there is no beam associated with an SSB with a reference signal received powers, RSRP, higher than or equal to a first configured threshold or associated with a CSI-RS with a RSRP higher than or equal to a second configured threshold; or
performing a fallback to a handover procedure with a RACH procedure in response to there is no beam associated with an SSB with a reference signal received powers, RSRP, higher than or equal to a first configured threshold or associated with a CSI-RS with a RSRP higher than or equal to a second configured threshold.

Preferably or in some embodiments, the wireless communication terminal performs at least one of the following operations to determine the UL resource:
selecting a Nth UL resource among the candidate UL resources in response to a starting scheduling timing and a scheduling interval being configured;
selecting a first available UL resource as a first available configured grant, CG, resource based on a CG configuration in response to the candidate UL resources are a subset or a complete set of CG resources; or
monitoring a PDCCH using a C-RNTI and taking a UL resource scheduled by the PDCCH as the UL resource to transmit the UL data.

Preferably or in some embodiments, the wireless communication terminal performs at least one of:
using a default HARQ process for a HARQ process for a transmission of the UL data;
being configured with a HARQ process identifier, and using the received HARQ process identifier for a HARQ process for a transmission of the UL data;
being provided with a range of HARQ process identifier, and using a HARQ process identifier withing the range for a HARQ process for a transmission of the UL data; or
determining a HARQ process for a transmission of the UL data based on a scheduling interval, a starting timing, and a number of configured HARQ processes.

Preferably or in some embodiments, the wireless communication terminal performs at least one of:
performing a logical channel prioritization procedure according to a HARQ process type;
receiving the configuration information comprising a bitmap indicating a HARQ process type for each HARQ process associated to pre-allocated resources;
receiving the configuration information comprising a common HARQ process type for each HARQ process associated to pre-allocated resources;
receiving the configuration information comprising an indication used to disable a HARQ process type associated to a HARQ process;
performing a logical channel prioritization procedure according to a predetermine rule; or
performing a logical channel prioritization procedure according to a default HARQ process type.

Preferably or in some embodiments, the wireless communication terminal performs a power control for a transmission of the UL data according to an active UL BWP for transmitting the UL data, a carrier for transmitting the UL data, and a serving cell of the wireless communication terminal.

Preferably or in some embodiments, the wireless communication terminal transmits a capability for supporting a handover procedure with a RACH procedure being skipped.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a timing relationship according to an embodiment of the present disclosure.

FIG. 2 shows a UE capability transfer according to an embodiment of the present disclosure.

FIG. 3 shows an example of a schematic diagram of a wireless terminal according to an embodiment of the present disclosure.

FIG. 4 shows an example of a schematic diagram of a wireless network node according to an embodiment of the present disclosure.

FIGS. 5 and 6 show flowcharts of methods according to some embodiments of the present disclosure.

FIG. 7 shows an example of angle information according to an embodiment of the present disclosure.

### DETAILED DESCRIPTION

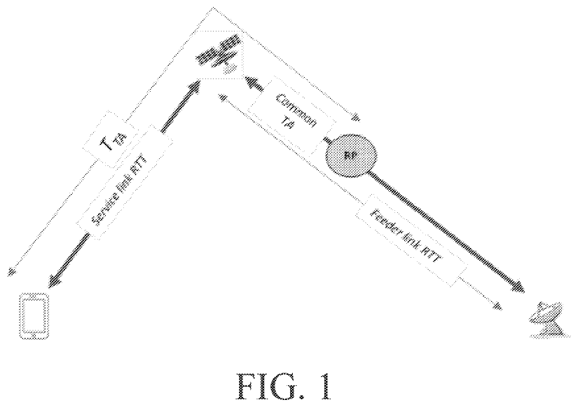

In some embodiments, to accommodate the propagation delay in NTNs, several timing relationships may be enhanced by a Common Timing Advance (Common TA) and the scheduling offsets K_offset and k_mac illustrated in FIG. 1.
Common TA is a configured offset that corresponds to the RTT (round trip time) between the Reference Point (RP) and the NTN payload.
K_offset is a configured scheduling offset that is larger or equal to the sum of the service link RTT and the Common TA.
k_mac is a configured offset that is correspondent to the RTT between the RP and the gNB.

The DL (downlink) and UL (uplink) are frame aligned at the uplink time synchronization reference point (RP) with an offset.

The offset k_mac is used to delay the application of a downlink configuration indicated by a MAC CE (Medium Access Control Control Element) command on a PDSCH (physical downlink shared channel) and an estimation of the UE-gNB RTT. It may be provided by the network when downlink and uplink frame timing are not aligned at the gNB. The k_mac is also used in the random access procedure to determine the start time of RAR (Random Access Response) window or MsgB window after a Msg1 or MsgA transmission.

For the serving cell, the network broadcasts valid ephemeris information and Common TA parameters. The UE may have a valid GNSS (global navigation satellite system) position as well as an ephemeris and a Common TA before connecting to an NTN cell. To achieve the synchronization, before and during a connection to an NTN cell, the UE may compute the RTT between the UE and the RP based on the GNSS position, the ephemeris, and the Common TA parameters, and autonomously pre-compensate the TA for the RTT between the UE and the RP.

The UE may compute the frequency Doppler shift of the service link, and autonomously pre-compensate for it in the uplink transmissions, by considering the UE position and the ephemeris. If the UE does not have a valid GNSS position and/or a valid ephemeris and a Common TA, it may not transmit until both are regained.

In a connected mode, the UE may be able to continuously update the Timing Advance and frequency pre-compensation.

The UE may be configured to report the Timing Advance during Random Access procedures or in the connected mode. In the connected mode, the event-triggered reporting of the Timing Advance is supported.

While the pre-compensation of the instantaneous Doppler shift experienced on the service link is to be performed by the UE, the management of the Doppler shift experienced over the feeder link and the transponder frequency error is left to the network implementation.

In some embodiments, due to the large transmission delay and huge coverage in NTN (non-terrestrial networks), methods can be considered to reduce the signaling delay as well as signaling overhead.

Current NTN is based on a premise that the transmission delay between UE and satellites can be pre-compensated by a UE (user equipment) and/or a NW (network). The NW will broadcast assisting information (e.g., satellite ephemeris, common TA relevant parameters, etc.) based on which the UE can derive the satellite's location (using satellite ephemeris), and the distance between the satellite and the UL synchronization reference point (RP) (using common TA parameters). Together with the UE's location information derived based on the GNSS module, the UE can perform the pre-compensation of the two-way transmission delay between the RP and the UE. Therefore, it is possible that the UE can have a similar TA in a target cell as in source if the pre-compensation is done properly. Moreover, it is possible for a UE to perform a RACH-less HO (handover (HO) without the RACH (Random Access Channel) procedure) in the NTN in such a case since no RACH is needed. The RACH procedure typically has 2 to 4 steps. If the RACH procedure can be skipped, it can save at least one round trip delay in the NTN, and thus the overall HO delay as well as signaling overhead can be reduced. In some embodiments, to support RACH-less HO in NTN deployed in NR, there may exist some issues when using the RACH-less HO in the NTN, such as:

NR support multiple beam operation where the scheduling of the UE is in a per-beam basis. Solutions need to be considered for allocating the UL resource with association to the beam (e.g., CSI-RS and/or SSB);
it is unclear how to manage the power used for the PUSCH transmission using the pre-allocated UL resource; and
it is unclear how to handle the case when UE cannot find an available UL grant for PUSCH transmission for a certain period of time.

Some embodiments of the present disclosure are provided in view of the above problems.

Some embodiments of the present disclosure are described in the context of NTN but is not limited thereto and can also be applied to other network types such as TN (territory network), ATG (air-to-ground), etc.

### RACH-Less HO (Handover)

In an embodiment, a RACH-less HO indicates a HO with a RACH procedure being skipped, or a HO without a RACH procedure.

In an embodiment, a RACH-less HO may comprise the following steps.

Step 1: In an embodiment, the UE receives and stores the (conditional) handover ((C) HO) configuration (e.g., a configuration for the RACH-less HO) from the NW (network (e.g., a network node)), which indicates that RACH can be skipped for this HO procedure. The HO types considered can be normal HO, CHO, DAPS HO, Conditional PSCell Addition and Change (CPAC) or other HO types may be supported in communication system.

Step 2: In an embodiment, the UE initiates a (C) HO procedure towards to target cell according to a configuration stored and/or received. The UE starts a T304 timer, which is used to control the HO procedure In some example (e.g., non-conditional HO), the timer T304 is started upon the reception of the message containing HO configuration (e.g., RRCReconfiguration message) In some example, e.g., for a CHO, the timer T304 starts upon the CHO execution.

Step 3: In an embodiment, during running of the timer T304, the UE transmits a PUSCH (e.g., contains RRCReconfigurationComplete message) to the gNB using the UL resource configured by the NW (e.g., according to the received configuration for the RACH-less HO), where the UL resource can be configured to the UE in a pre-configured or dynamic scheduled manner. In an embodiment, the PUSCH is for the RACH-less HO. In an embodiment, the PUSCH is for initiates the RACH-less HO with the gNB.

Step 4: In an embodiment, if the UE determines that the RACH-less HO is successful (e.g., successfully receives a PDCCH transmission addressed to the C-RNTI (Cell Radio Network Temporary Identifier)), the UE stops the T304 timer and releases the configuration for the RACH-less HO.

For step 1:

In an embodiment, the configuration for the RACH-less HO may include at least one of the following:
An indication that the RACH can be skipped. The indication can be an explicit indication or implicit indication. In an embodiment, the presence of the configuration used for the UE to skip RACH can be regarded as indication for the UE to skip the RACH procedure.
TA (timing advance) information, which is used to indicate the TA to be applied in the target cell. In an embodiment, the TA information may indicate to the UE to maintain the TA associated to a TAG (timing advance group) or indicate to the UE to autonomously pre-compensate the TA based on the assisting information (e.g., satellite ephemeris, common TA parameters, etc.) associated to the target cell. In one example, this information can be a one-bit indication, where value 1 indicating UE to use source TA in target cell, zero means UE needs to recalculate the TA based on the assisting information (e.g., satellite ephemeris, common TA parameters, etc.), or vice versa. In another example, this information can be an indication, where presence of this information indicates that UE uses source TA in target cell absence of the indication indicates UE needs to recalculate the TA based on the assisting information (e.g., satellite ephemeris, common TA parameters, etc.), or vice versa. In another embodiment, (e.g., in case dual connectivity carrier aggregation, DCCA), the TA information used to indicate the indicate the TA to be applied in target cell maybe select among the TAs of different TAGs associated to MCGs or SCGs, which can be enabled by introducing an TA Information Element (IE) with a choice structure, to choose one TA to be used among the TAs of different TAGs. The TA of difference TAGs can either be identified by TAG IDs or by the IE names (e.g., MCG_PTAG). In this example, absence of the TA IE can be used to indicate that UE needs to recalculate the TA based on the assisting information (e.g., satellite ephemeris, common TA parameters, etc.) In some example, to allow future extensions, extension fields can be included. An example could be introduce a new IE with one field indicating target TA as Primary TAG of value null, and extension marks can be used for future extension. Meanwhile the absence of this IE can be used as implicit indication that UE shall calculate the TA based on the NW assisting information.
A UL grant resource configuration. This configuration can be optionally configured. When configured with pre-allocated UL grant resource based on received UL grant resource configuration, UE may selects among the pre-allocated UL resource for PUSCH transmission. In some example, UE will also monitor PDCCH to receives UL grant scheduled by dynamic grant, and transmits the PUSCH on the earliest available grant scheduled. In some example, when pre-allocated UL grant resources not provide, UE can also monitor PDCCH to receives dynamic grant for PUSCH transmission. The UE may behave differently in Step 3 which will be discussed in detail below.
Power control relevant information.
Information for the UE to perform a fallback to a HO with the RACH procedure.
An SR (scheduling request) configuration.
a beam relevant configuration The beam can includes one or more beam information as discussed below for UL grant resource configuration of pre-allocated grant (e.g., SRS resource information, TCI sate configuration and etc.). In some example, the beam relevant configuration here is independent from the beam information associated to pre-allocated grant.
a physical downlink control channel (PDCCH) configuration. The configuration can includes at least one of the control resource set (CORESET), search space information, the associated TCI state information.
a physical uplink control channel (PUCCH) configuration The configuration can includes at least one of associated TCI state information, the SR configuration, CSI configuration, allowed multiplexing pattern information and etc.
a configuration for an early TA acquisition.

In an embodiment, the configuration may be delivered to the UE using at least one of: system information (e.g., MIB (Master Information Block) or SIB (System Information Block) (e.g., SIB1, SIB2, etc.), a dedicated RRC signaling (e.g., RRCReconfiguration message), a paging message, other common signaling that is target for a group of UEs (e.g., multicast or groupcast), Non Access Stratum (NAS) message or MAC signaling (e.g., MAC CEs) or via Downlink control information (DCI).

### UL Grant Resource Configuration

In an embodiment, the UL grant resource configuration gives the configuration of pre-allocated grant for the PUSCH transmission when the UE performs the handover to a target.

In an embodiment, the UL grant resource configuration may include at least one of:
A code domain resource.

In an embodiment, the code domain resource may include at least one of, a DMRS (demodulation reference signal) resource configuration, an MCS (modulation and coding scheme) configuration, or a redundancy version. In an embodiment, the MCS configuration can have one or multiple index/indices, where each index refers to an MCS. In an embodiment, the modulation and coding scheme may include a modulation order, a TBS (Transport Block Size) index, and/or a redundancy version.
A time domain resource.

In an embodiment, the time domain resource may include at least one of: A duration of time resource used (e.g., number of resource blocks), a start of time domain resource of each grant, a time domain allocation combination (e.g., indicating a combination of a start symbol and a length and a PUSCH mapping type), a scheduling interval (e.g. indicating the periodicity of the granted resource allocated in the time domain), a scheduling start timing which may indicate the start timing of the granted resource, a time domain allocation type information, e.g., type 0, type 1 or dynamic switch, (in an embodiment, it can be specified that only one allocation type is considered for this pre-allocated grant), or a TBS configuration (e.g., indicating the target transport block size).
A frequency domain resource configuration.
A subcarrier Spacing (SCS) configuration.
Antenna port information, which indicates antenna ports used for this configuration.
Information whether a transform precoding is used.
The time and/or frequency domain resource to transmit HARQ (hybrid automatic repeat request) acknowledge information.
A CSI request bit, which is used to determine whether a CSI (channel status information) report can be used in the PUSCH transmission.
The HARQ process number used for the PUSCH transmission.

In an embodiment, the range of the HARQ process number used for the PUSCH transmission may be from zero to 16. If an extended HP (HARQ Process) is used, the range may be from zero to 32. Other value ranges may also be feasible.
Information indicating whether the HARQ feedback is disabled or not.

In an embodiment, for information indicating whether the HARQ feedback is disabled, in a case that the HP is configured with disabled feedback, at least one of the following options may be used on the issue that how to handle whether feedback is needed to be transmitted or not:
A) the UE follows the feedback status configured for the selected HARQ Process (HP);
B) the UE always sends feedback regardless the feedback status configured for the selected HP; and/or
C) based on an explicit configuration, one indication is used to indicate whether the UE is expected to send feedback to the NW. For example, i) if the explicit indication is configured, the UE prioritizes the selection of the HP that is configured with feedback allowed; ii) if the explicit indication is configured, the UE always sends ack regardless of the HO status; iii) if the explicit indication is not configured, the UE is not required to send feedback regardless of the HP feedback status configured; and/or iv) if the explicit indication is not configured, the UE follows the HP feedback status to know whether to send feedback.
Information to determine the HARQ type information.

In some examples the HARQ type mentioned discussed in this application means the uplink HARQ mode (mode A or mode B) as specified in 3GPP standards

In an embodiment, the information to determine the HARQ type information includes at least one of: explicitly indicated information (e.g., type A or type B), or an indication that may be used to disable the UL transmission type configured for the HARQ process.
A validity duration or a timer length.

In an embodiment, the validity duration indicates the time duration which the configured pre-allocated UL resource for transmitting the PUSCH is considered as valid. In an embodiment, a timer can be used for this duration. In an embodiment, during running of the timer, the UE may determine that the configuration for the pre-allocated UL resource for transmitting the PUSCH is valid, and, based on the configuration for the pre-allocated UL resource, select the resource for the PUSCH transmission. In an embodiment, upon the expiry of the timer, the UE can determine that the configuration for the pre-allocate UL resource is invalid and release the configuration and/or corresponding resource.

In an embodiment, the start point of this timer may be a time point after the UE's first selection of the UL grant for the PUSCH transmission. In an embodiment, the start point may be upon the HO execution. In an embodiment, the start point may be upon the reception of the RRCReconfiguration that is not for the CHO, and includes the RACH-less HO configuration (e.g., for non-CHO cases). In an embodiment, for CHO, the starting time may be determined according to the CHO configuration or upon the first CHO execution or the latest CHO execution. Or in another example, the start timing of this timer could be the time point T304 is started, or in some example the start timing is the first time T304 is started for this HO procedure.
A priority index associated to the pre-allocated resource for transmitting the PUSCH.

In an embodiment, the priority index may indicate the PHY (physical) priority of the PUSCH using the pre-allocated resource. In an embodiment, this information can at least be used for PHY-layer (physical layer) collision handling. For example, value p0 indicates low priority and value p1 indicates high priority. In an embodiment, this information may not be needed to configure for pre-allocated resource, and in such a case, a default priority may be adopted.
The beam information associated with the UL grant resource for transmitting the PUSCH.

In an embodiment, for the beam information associated with the UL grant resource described above, in case the pre-allocated resource for transmitting the PUSCH is configured and the association to beam (SSB (Synchronization Signal/Physical Broadcast Channel Block) and/or CSI-RS (channel status information reference signal)) is given, when selecting among the pre-allocated UL grant resource for the PUSCH transmission, the UE may first select the beam, and then select the UL resource mapped to the selected beam. In an embodiment, this configuration may include at least one of: A beam type (e.g., SSB and/or CSI-RS); a beam index (one or more beam index/indices, e.g., an SSB index, a CSI-RS index, which indicates the beams for the pre-allocated UL resource for transmitting the PUSCH); a beam subset for beams (e.g., SSBs or CSI-RSs) to pre-allocated PUSCH mapping within one Configured Grant configuration; in some example, it can be indicated by a bitmap; a number indicating the number beams (e.g., SSBs or CSI-RSs) per pre-allocated PUSCH; the number of DMRS sequences for beam (e.g., SSBs or CSI-RSs) to PUSCH mapping, the set of DMRS ports for beam (e.g., SSBs or CSI-RSs) to PUSCH mapping. one or more thresholds for the UE to select a suitable beam for the PUSCH transmission, which can be configured separately for the SSB and/or CSI-RS; a mapping relationship between the PUSCH resource and the configured beam (the SSB and/or CSI-RS); an SRS (sounding reference signal) resource indicator; a mapping pattern for the SRS resource; a TCI (Transmission Configuration Indication) state configuration (e.g., IDs to identify a TCI state (e.g., TCI-Stateld)) TCI-State associates one or two DL reference signals with a corresponding quasi-colocation (QCL) type; the BWP information; and/or the UL carrier information.

In some examples, the UE may first select the beam and then select the UL grant resource associated to the beam selected for the PUSCH transmission.

In an embodiment, for the beam selection, at least one of the below may apply:
i) the UE selects among of the SSBs and/or CSI-RSs that with an RSRP (reference signal received power) higher than one or more configured thresholds;
ii) the UE selects among of the SSBs and/or CSI-RSs that with an RSRP higher or equal to one or more configured thresholds;
iii) if there is no beam that fulfils the threshold requirement, the UE may select any beam available; or
iv) if there is no beam that fulfills the threshold requirement, the UE may fall back to perform the HO with a RACH when a predetermined certain condition is met.

In an embodiment, the mapping relationship between the UL resource for transmitting the PUSCH and the configured beam (the SSB and/or CSI-RS) may conform with at least one of: the mapping relationship can follow the pre-defined rules for the CG-SDT, and/or it can follow the pre-defined rules for MsgA PUSCH mapping to preamble.

In an embodiment, the SRS resource indicator may be used for the beam selection based on the correspondence between the DL and UL beam. If based on the SRS measurement, a DL beam with best quality is selected (e.g., associated to SSBx, and x is an integer), it is assumed that the same beam (e.g., SSBx in this example) will be used for the UL transmission.

In an embodiment, the mapping pattern for the SRS resource indicates whether the UE may follow a cyclical mapping pattern or a sequential mapping pattern when two SRS resource sets are configured.

In an embodiment, the TCI state configuration indicates one or more activated TCI states associated to the corresponding configured RS (reference signal) resource (e.g., CSI-RS). Each TCI state configuration can include at least one of a TCI state id (e.g., to identify the TCI state configuration), power control information, one or two QCL information, BWP information where the RS is located in, reference signal resource associated with this TCI state, QCL type (e.g., typeA, typeB, typeC or typeD). In an embodiment, in case a TCI configuration is given, it can be used together with other parameters mentioned. The UE based on the TCI state id to locate the reference signal resources (e.g., CSI-RS) associated with the activated TCI states. In some examples, the UE may further determine the selected reference resources (e.g., CSI-RS)′ RSRP is qualified or not, e.g., whether the RSRP is above the threshold configured for the beam selection for the pre-allocated grant resource for transmitting the PUSCH.

In an embodiment, the BWP information indicates the configuration of the BWP associated with the pre-allocated grant resource for transmitting the PUSCH. In an embodiment, the BWP information includes at least one of: the starting point of the BWP location in the frequency domain with respect to the absolute point A (e.g., a reference), the bandwidth of the BWP, the frequency location of the absolute point A, and/or the SCS information (e.g., 15 KHz).

In an embodiment, the UL carrier information indicates the information on whether the selected UL is an NUL (Normal Uplink) or SUL (Supplementary Uplink). In an embodiment, the UL carrier information can have the value of NUL or SUL. In an embodiment, the UL carrier information can have the format of a 1-bit indication, where 0 indicates NUL 1 indicates SUL or vice versa.

In an embodiment, the pre-allocated UL grant resource for transmitting the PUSCH can be the whole, or a subset of configured grant resources configured for the UE. An example is given below.

### Example

In an embodiment, the configuration includes at least one of: a starting scheduling timing (in an embodiment, if configured, the UE uses the first available CG resource among the candidates CG resource after the starting timing as the UL resource for the PUSCH transmission); a scheduling interval (in an embodiment, if configured, the UE searches a first available UL resource for the PUSCH transmission based on the scheduling interval configured among the candidate CG resources); or the information used to indicate the candidate CG resource that is used for the PUSCH transmission in the RACH-less HO. In an embodiment, the information may include at least one of: configuredGrantConfigIndex, which indicates the index of the CG resource, and is used to uniquely identified the configured CG resource within a CG resource list within the selected BWP; configuredGrantConfigIndexMAC, which indicates the CG resource index uniquely within one MAC entity; a beam subset for beams (e.g., SSBs or CSI-RSs) to pre-allocated PUSCH mapping within one Configured Grant configuration (in some example, it can be indicated by a bitmap); a number indicating the number beams (e.g., SSBs or CSI-RSs) per pre-allocated PUSCH; the number of DMRS sequences for beam (e.g., SSBs or CSI-RSs) to PUSCH mapping, the set of DMRS ports for beam (e.g., SSBs or CSI-RSs) to PUSCH mapping; and/or parts or a complete set of information elements included in the configuration ConfiguredGrantConfig for the CG.

In an embodiment, when the UL resource is not overlapped with other UL resource (e.g., for example, for the MsgA or for the SR), it is considered as being available. Other rules can also be applied.

In an embodiment, the pre-allocated UL grant resource for transmitting the PUSCH may be the whole, or a subset of configured grant resources for the CG-SDT (configured grant small data transmission) configured for UEs.

### Power Control Relevant Information

In an embodiment, the power control relevant information may include at least one of:
a target power level, in particular the target power level for the PUSCH transmission;
a delta power configuration, in particular the delta power level used in the transmission power calculation for the transmission of the PUSCH;
a type of the RACH to be considered; in an embodiment, the UE follows the power control procedure for the PUSCH transmission scheduled by the random access response for the type of the RACH indicated in this indication; in an embodiment, if only one type of the RACH is configured, this configuration can be omitted;
an alpha value (e.g., a factor) for the PUSCH for pre-allocated UL grant resource;
in an embodiment, an example value range could be {alpha0, alpha04, alpha05, alpha06, alpha07, alpha08, alpha09, alpha1} where alpha0 indicates value 0 and alpha04 indicates value 4 and so on. This alpha value can be used for a power control determination;
an nominal power level, a nominal power level for PUSCH transmission for pre-allocated UL grant; and/or
a P0 value for PUSCH transmission for pre-allocated UL grant.
   Configuration for UE to Fallback to Handover with RACH

In an embodiment, a configuration of the fallback to the HO with the RACH may include a timer. In an embodiment, the timer is used for triggering the UE to fallback to the HO with the RACH. In an embodiment, the start point of this timer can be after the UE first selection of the UL grant resource for the PUSCH transmission. In an embodiment, the start point can be upon the HO execution. In an embodiment, the start point may be upon the reception of RRCReconfiguration that is not for the CHO, and includes the RACH-less HO configuration (for non-CHO cases). In an embodiment, for the CHO, the starting time can be upon the CHO configuration or upon the first CHO execution or the latest CHO execution.

In an embodiment, upon the expiry of this timer, the UE may initiate the RACH in the target cell for synchronization and obtaining the UL resource for the PUSCH transmission.

In an embodiment, upon the initiation of the RACH, the UE may release the pre-allocated resource, if any.

In an embodiment, the UE may keep the pre-allocated resource, if any. In an embodiment, the UE may utilize the latest UL resource either among the pre-allocated grant or scheduled in Random access response or via dynamic scheduling.

Upon initiating the RACH, the UE may still use the C-RNTI to monitor PDCCHs (physical downlink control channels). In an embodiment, the UE may terminate corresponding on-going RACH or consider the RACH as completed when receives successfully the PDCCH scheduled by C-RNTI. In an embodiment, if the UE receives the PDCCH scheduled DL transmission containing a TC-RNTI (Temporary C-RNTI), the UE may ignore the received TC-RNTI.

### SR (Scheduling Request) Configuration

In an embodiment, the SR configuration may include at least one of:
An indication whether the SR can be initiated when there is no available UL resource. In an embodiment, the indication may be used in combination with the timer discussed above. In an embodiment, upon the expiry of the timer, and if the SR configuration indicates triggering the SR is allowed, the UE can trigger the SR to request for the UL resource for the transmission of the PUSCH. In an embodiment, the SR may be cancelled when the PUSCH has been successfully transmitted, or when the PDCCH scrambled by the C-RNTI is successfully received.
Dedicated SR configuration. In one example, the SR configuration includes at least one of a SR periodicity; a priority index, indicates whether this scheduling request resource is high or low priority in PHY prioritization/multiplexing handling; a PUCCH resource in which the UE shall send the scheduling request; ID of the PUCCH resource in which the UE shall send the scheduling request; The ID of the SchedulingRequestConfig that uses this scheduling request resource.

In an embodiment, when the SR is allowed for the UE to request for the UL resource during the RACH-less HO, at least one of the following may be applied for the UE to select the SR resource used for transmission of the SR.
The UE uses a dedicated SR resource for sending the SR.
The UE randomly selects among the available SR resources for sending the SR.
The UE selects the latest SR resource among the available SR resources for sending the SR.
When the request resource is for a CCCH (Common Control Channel) message, the UE selects the SR resource with the highest priority for sending the SR.

In one embodiment, a configuration for early TA acquisition. The configuration includes at least one of indication indicate it is a configuration for early TA acquisition, a RACH configuration for UE to perform early TA acquisition.

In one implementation the indication indicating is a configuration for early TA acquisition can be indicated by the presence of the configuration.

In one implementation, the configuration of the early TA RACH is a cell specific configuration. In the Configuration, the configured RACH resources are shared with the CBRA triggered by other purpose, e.g., initial access. In one implementation, the configuration of the early TA RACH is a user specific configuration, which contains contention free resource configuration. For above mentioned RACH configuration, at least one of the time domain, code domain or frequency domain resource can be configured. In one implementation, absence of RACH configuration can imply UE to use other RACH resource configured, e.g., the common RA resource configured in system information.

### For Step 3:

### How to Select the Pre-Allocated Grant Resource for Transmitting the PUSCH

In an embodiment, the UE may select the first available UL resource among the configured resources, which can be either pre-allocated or dynamically scheduled. In an embodiment, the UE may further select the beam based on the RSRP threshold as discussed before. In an embodiment, the UE selects the beam with the RSRP above the RSRP threshold configured for the RACH-less HO.

In an embodiment, at least one of the following options may be used for determining the resource for transmitting the PUSCH:

Option 1: In a case that a starting scheduling timing and a scheduling interval is configured, UE selects the resource corresponding to the N^{th} grant occurs in timing for transmitting the PUSCH, for which Timing=[N*(scheduling interval)+(starting scheduling timing)] modulo UNIT. The UNIT depends on the granularity used for configuring the parameters. In an embodiment, the UNIT equals to the number of granularities contained within one radio frame. In an embodiment, in a case that the granularity is sub-frame, the UNIT equals to the number of sub-frames per radio frame (e.g., 10). In an embodiment, in a case that the granularity is slot, the UNIT depends on the SCS.

Option 2: In a case the UL resource is subsets or complete sets of configured grant resources configured by the network, the UE determines the first available UL resource by using the first available CG resource based on the CG configuration (e.g., the periodicity and the SCS).

Option 3: The UE monitors the PDCCH using the C-RNTI and uses the UL resource scheduled by the received PDCCH as the resource for transmitting the PUSCH.

In an embodiment, a combination of the above options can be considered. In an embodiment, Option 1 and Option 3 can be used together. In an embodiment, the UE may select the resource among pre-allocated grants while monitoring the PDCCH and uses the first available UL resource for the transmission. In an embodiment, Option 2 and Option 3 can be used together. In an embodiment, the UE may select the resources among candidate CG grant resources while monitoring the PDCCH and uses the first available UL resource for the transmission.

### Determining the HP Used for the Selected UL Resource

In an embodiment, at least one of the below options may be used for determining the HPs used for the selected UL resource.
A default HP is used for the transmission of the HPs (e.g., HP zero).
The HP ID is configured explicitly to the UE.
A range of HP ID is provided. In an embodiment, the UE selects the range from the lowest to the highest number. In an embodiment, the first available HPs can be used.
If a scheduling interval and a starting timing is considered, the UE may determine the HP based on the information provided together with the number of the configured HP. An example equation is as below:
HARQ Process ID=[floor (CURRENT_symbol/(scheduling interval))] modulo (the number of HP configured),
where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot.

In an embodiment, if the pre-allocated UL grant resource is a subset or complete set of configured grant resources, the equation used for the HP calculation for the correspondent configured grant type may be used for the calculation of the HP for the pre-allocated UL grant resource.

### Determining the HP Type and Perform LCP (Mapping the PUSCH to HPs)

In an embodiment, the HP type information (if configured) can be used in the logical channel prioritization procedure (LCP). In an embodiment, at least one of the methods below may be used when it comes to determining the HP type and using the HP type in the LCP.

In an embodiment, the HP type may be determined based on the information received in the configuration for the RACH-less HO, which indicates the HARQ type associated to the HP, e.g., type A or type B.

In an embodiment, a bitmap can be used to indicate the HARQ type for each HPs associated to the pre-allocated resources.

In an embodiment, a common HP type is configured for all HPs associated to the grant resource. For example, when the UE selects the pre-allocated resource for the PUSCH transmission and determines the HP to be used for the PUSCH transmission, the UE may use the HP type configured for the pre-allocated grant resource regardless of the previously configured one (if any). In an embodiment, the UE may use the common HP type when performing the LCP.

In an embodiment, an indication is used to disable the HP type associated to the selected HP (if any). In an embodiment, when the indication indicates the UE to disable the HP type, the UE may not use the HP type (if configured) when it performs the LCP. That is, the UE may not apply the LCP defined for the HARQ type.

In an embodiment, a pre-defined rule may be used without configuration. In an embodiment, the UE may not use the HP type in the LCP when the PUSCH transmission uses the pre-allocated resource.

In an embodiment, a default HP type is used for the HP when the PUSCH transmission uses the pre-allocated resources (e.g., type A or type B).

### Power Control for PUSCH Transmission Using Pre-Allocated Grant Resource

In an embodiment, at least one of close-loop and open loop power control can be considered for power control of PUSCH transmission for pre-allocated grant

For the close-loop power control, at least one of the below may be considered.

In an embodiment, the power control follows the rules used for the PUSCH scheduled by the UL grant. In an embodiment, since there may be two types of RACH (e.g., 2 steps RACH or 4 steps RACH), the NW can indicate which type of the RACH the power control refer to. In an embodiment, the UE may decide based on the procedure which power parameters can be used for a pre-allocated UL resource for transmitting the PUSCH.

In an embodiment, the power control follows the rules used for the PUSCH scheduled by the configured grant.

In an embodiment, the power control follows the rules used for the PUSCH scheduled by the CG-SDT.

In an embodiment, if a UE transmits a PUSCH on active UL BWP b of carrier f of serving cell c using the parameter set configuration with index j and the PUSCH power control adjustment state with index l, the UE determines the PUSCH transmission power P_{PUSCH,b,f,c}(i, j, q_{d}, l) in PUSCH transmission occasion i as

$${P}_{PUSCH , b , f , c} ( i , j , {q}_{d} , l ) = min \{ \begin{matrix}{P}_{CMAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ]$$

where,
   P_{CMAX,f,c}(i) is the UE configured maximum output power for carrier f of serving cell c in PUSCH transmission occasion i.
   P_{O_PUSCH,b,f,c}(j) is a parameter composed of the sum of a component P_{O_NOMINAL,PUSCH,f,c}(j) and a component P_{O_UE_PUSCH,b,f,c}(j) where j∈{0, 1, . . . , J−1}.
   PL_{b,f,c}(q_{d}) is a downlink pathloss estimate in dB calculated by the UE using reference signal (RS) index q_{d} for the active DL BWP of carrier f of serving cell c.

$${M}_{RB , b , f , c}^{PUSCH} ( i )$$

is the bandwidth of the PUSCH resource assignment expressed in number of resource blocks for PUSCH transmission occasion i on active UL BWP b of carrier f of serving cell c and μ is a SCS configuration

$${Δ}_{TF , b , f , c} ( i ) = 10 {log}_{10} ( ( {2}^{BPRE \cdot {K}_{s}} - 1 ) \cdot {β}_{offset}^{PUSCH} )$$

for Kₛ=0 where Kₛ is provided by deltaMCS for each UL BWP b of each carrier f and serving cell c.

$${f}_{b , f , c} ( i , l ) = {f}_{b , f , c} ( i - {i}_{0} , l ) + {\sum }_{m = 0}^{C ( {D}_{i} ) - 1} {δ}_{PUSCH , b , f , c} ( m , l )$$

is the PUSCH power control adjustment state l for active UL BWP b of carrier f of serving cell c and PUSCH transmission occasion i if the UE is not provided tpc-Accumulation, or f_{b,f,c}(i, l)=δ_{PUSCH,b,f,c}(i, l) is the PUSCH power control adjustment state for active UL BWP b of carrier f of serving cell c and PUSCH transmission occasion i if the UE is provided tpc-Accumulation.

The min function as shown in above equation means UE choose the smaller one among all the candidates.
If a UE uses the pre-allocated UL grant and is not provided the Alpha value:
if the power control of pre-allocated UL grant follows similar the power control rules for PUSCH scheduled by random access response UL grant:

$$j = 0 , {P}_{O\_UE \_PUSCH , b , f , c} ( 0 ) = 0 , and {P}_{O\_NOMINAL , PUSCH , f , c} ( 0 ) = {P}_{O\_PRE} + Δ ,$$

where P_{O_PRE} is provided by the configured initial target power and Δ is provided by a delta power configuration parameter, or Δ=0 dB if the delta power configuration is not provided, for carrier f of serving cell c.
If a UE uses the pre-allocated UL grant configured by ConfiguredGrantConfig:
j=1, P_{O_NOMINAL,PUSCH,f,c}(1) is provided by nominal power value. In case this nominal power value is not provided, UE can assumes P_{O_NOMINAL,PUSCH,f,c}(1)=P_{O_NOMINAL,PUSCH,f,c}(0). And, P_{O_UE_PUSCH,b,f,c}(1) is provided by p0 obtained from the P0 value configured for pre-allocated grant.
If a UE uses the pre-allocated UL grant and is provided the Alpha value:
For α_{b,f,c}(j)
For j=0,
if P_{O_NOMINAL,PUSCH,f,c}(0)=P_{O_PRE}+Δ and Alpha for pre-allocated grant is provided, α_{b,f,c}(0) is the value of the alpha value configured for pre-allocated grant
else, α_{b,f,c}(0)=1
For j=1,
α_{b,f,c}(1) is provided by alpha obtained from the alpha value configured for pre-allocated grant

### For Early TA Acquisition

A typical use case for early TA acquisition would be when configuring RACH-less HO together with CHO. To guarantee that the CHO candidate cells to be selected for RACH-less HO can have a valid TA value. The NW may transmit to UE an early RACH command asking UE to acquiring TA through a RACH procedure. And at least one of below options can be considered:
In one implementation, the early RACH Command may be a L1 signaling (e.g. DCI), which may include at least one of the following information:
Candidate Cell Group ID: To identify the Candidate cell group to which a cell belong whose TA value is acquired.
Candidate Cell ID: To identify the candidate cell whose TA is acquired.
SSB or CSI-RS ID: To indicate the SSB or CSI-RS to be selected for RACH resource selection when initiating the early RACH.
Preamble ID: To indicate the Preamble to be selected when initiating the early RACH, if value of such field is present as 0, the CBRA shall be applied (i.e the preamble and/or RO is selected by MAC entity)
RO ID or/and PRACH MASK: To indicate the RACH occasions to be selected when initiating the early RACH.
In another implementation, the early RACH Command may be a L2 signaling (e.g MAC CE), which may include at least one of the following information:
Candidate Cell Group ID: To identify the Candidate cell group to which a cell belong whose TA value is acquired.

Candidate Cell ID: To identify the candidate cell whose TA is acquired.
SSB or CSI-RS ID: To indicate the SSB or CSI-RS to be selected for RACH resource selection when initiating the early RACH.
Preamble ID: To indicate the Preamble to be selected when initiating the early RACH, if value of such field is present as 0, the CBRA shall be applied, (i.e. the preamble selection is by MAC entity)
RO ID or/and PRACH MASK: To indicate the RACH occasions to be selected when initiating the early RACH.
To a Logical channel index (e.g., LCID or eLCID) may be used to identify the MAC CE used for triggering the early RACH to acquire TA.
After receiving early RACH command UE may apply the RRC Configuration of the early RACH according to the received early RACH command.
UE initiate the RACH procedure according to the applied RRC Configuration of the RACH and the received early RACH command.

To determine the RACH type initiated, UE may consider below implementation. In one implementation, The RACH type may include the following:
1: CFRA (Contention Free RACH): the PRACH resources used for the RACH are deliberately configured to UE.
2: CBRA (Contention based RACH): The PRACH resources used for the RACH are selected by the MAC entity of the UE. In one implementation, if the CBRA is initiated for the early RACH, the MSG.3 and MSG.4 is no longer needed, in other words, UE may consider the CBRA based early RACH is successfully terminated when successfully receiving and decoding the RAR (i.e., MSG 2).

For determining the type of the early RACH, at least one of the following mechanisms may be applied:
1: If the PRACH Resources (i.e. Preamble ID and/or PRACH MASK) and SSB ID/CSI-RS ID is not present or the PRACH Resources are present as 0b000000 in the early RACH command, The CBRA is initiated. Otherwise, the CFRA is initiated.
2: If the PRACH resources indicated by the early RACH command is from the UE dedicated RACH resources, the CFRA is initiated. If the PRACH resources indicated by the early RACH Command is from the cell specific RACH resources, the CBRA is initiated.
3: The RACH type for the early RACH may be upon an information element configured in the RRC configuration associated with the candidate cell.

After performing the RACH to candidate cells, UE may notify to serving cell that it has finished the acquisition of TA through the RACH procedure. And at least one of below implementation can be considered:
In one implementation, UE may trigger and send an SR on the serving cell as soon as the UE comes back to the serving cell.
In one implementation, UE may send an SRS on the serving cell.
If RAR is present, in one implementation, UE may generate and send a UL MAC CE to the serving cell in order to inform of switching back, in one implementation, one SR may be triggered when there is no any available PUSCH can accommodate the triggered UL MAC CE.
If RAR is not present, the timing when sDU receiving the F1 message where the TA information associated with UE and target cell is contained.
Serving cell may configure a EarlyRACH-ControlTimer for UE to initiate the early RACH procedure at the candidate cell, the timer behavior may be as below:
   Start/Restart: may Upon the reception of the early RACH command.
   Stop: may upon the reception of the RAR.
Expiry: may stop the ongoing early RACH, if any, and switch back to the serving cell immediately.
   If the Serving Cell and Candidate Cell is within the Same DUs:
Assuming the RAR is present on the candidate cell, the RAR may include the UL grant of the serving cell, UE can perform the UL transmission on the serving cell in order to notify serving cell of coming back.

UE may also inform the acquired TA information of the candidate cells so that the understanding or TA information between UE and serving cell is the same. And at least one of below methods can be considered:

To introduce a UL MAC CE (e.g., UL TA Sync MAC CE) to indicate the TA value of the candidate cell that has been successfully obtained. For keeping the TAT being aligned between UE and NW, there are at least one of the following mechanisms for UL Time Advance Sync MAC CE:
TA sync is triggered and pending by the successful Reception and decoding of the RAR on the candidate cell
MAC entity generates the UL TA Sync MA CE when there is available PUSCH on the serving cell which can accommodate the UL TA Sync MAC CE, in one implementation, the serving cell may be the SpCell, in another implementation, the serving cell may be either SCell or SpCell.
If there is no available PUSCH resources for accommodating the UL TA sync MAC CE, one SR shall be triggered and pending.
the TAT (i.e., timeAlignmentTimer) may be restarted/started when the UL TA Sync MAC CE MAC CE is sent to NW
For the UL time Advance Sync MAC CE, it may contain at least one of the following fields:
TA value: To indicate the TA value of the candidate cell and/or TAG to the serving cell.
Candidate Cell information:
TAG information:

The left TAT length: To indicate the left TAT length of the TA value, the left length of the TAT is calculated based on the moment of sending the UL time Advance Sync MAC CE.

In some examples, it is optional for UE to support early TA acquisition, and an capability bit can be used to indicate whether UE support this feature. Similar signaling procedure as discussed in below capability signaling section can be used for reporting the capability to NW. In another example, it is conditional mandatory for UE to support this feature, e.g., if UE supports RACH-less together with CHO, it is mandatory for UE to support early TA acquisition.

### For Step 1: Capability Signaling

Example 1: In an embodiment, the support of the RACH-less HO can be an optional feature for the UE. In an embodiment, this feature can be optional without signaling. In an embodiment, if the UE does not support this feature, it may ignore the received configuration for the RACH-less HO.

Example 2: In an embodiment, the support of the RACH-less HO can be an optional feature for the UE. In an embodiment, one capability is used to indicate whether the UE supports this feature. In an embodiment, if the UE does not support this feature, the NW may not transmit the configuration for the RACH-less HO to the UE.

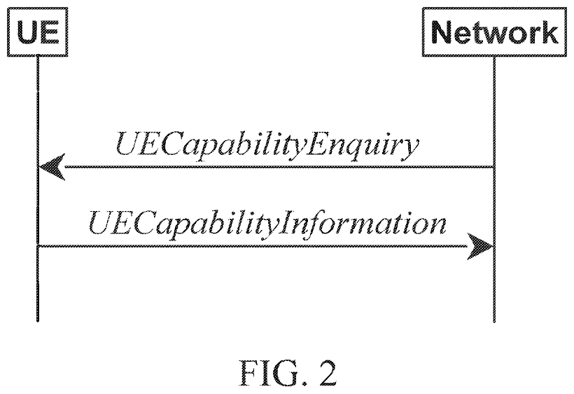

In an embodiment, the capability bit can be transferred in the UE capability signaling as shown in FIG. 2.

FIG. 2 shows an example of enquiring the UE capability information. The NW may send a first message to enquiry the UE capability, and the UE may send the UE capability information to inform the NW about its capability. In an embodiment, the NW may, based on the capability information it received, decide whether to transmit the configuration for the RACH-less HO to the UE. In an embodiment, the NW may transfer the UE capability information received between different NW nodes. In an embodiment, if the UE does not support the RACH-less HO, the UE can ignore the configuration for the RACH-less HO.

Example 3: In an embodiment, the support of the RACH-less HO may be conditional/optional for the UE. Thus, the support of the RACH-less HO may be dependent on some conditions preconfigured. In an embodiment, the UE supports the RACH-less HO if the UE supports the HO. In an embodiment, the UE supports the RACH-less HO if the UE supports the NTN.

Example 4: In an embodiment, the UE mandatorily supports the RACH-less HO.

In some embodiments of the present disclosure, methods on how to configure the pre-allocated resource for RACH-less in NR is discussed, which includes associating the UL resource with the beam and selecting the UL resource as parts of the CG configuration.

In some embodiments of the present disclosure, methods on how to perform the power control of the PUSCH transmission using the pre-allocated resource is discussed.

In some embodiments of the present disclosure, methods on how to determine the HP ID and HP type associated to the PUSCH transmission using the pre-allocated resource is discussed.

In some embodiments of the present disclosure, methods on how to perform capability signaling for the RACH-less HO in the NTN.

With the configurations above, the handover procedure and reliability of communication can be improved, and therefore the NW performance can be improved.

Another enhancement can be considered to reduce signaling overhead, improve system mobility performance is to allow UE to reuse the same Physical Cell Identity (PCI) when service link and/or feeder-link switch caused due to movement of satellite. This feature is also referred as unchanged PCI in this application.

A typical use case for service link switch without changing PCI is for quasi-earth fixed cell where the cell coverage with respect to a geographical area remains unchanged with a certain period of time. For UE within such area, since the radio seen by UE are similar after the service link switch, it is possible to reuse the same PCI with or without involves L3 mobility procedure (e.g., HO). If L3 mobility procedure is not applied, then the signaling overhead used for L3 mobility procedure can be reduced for UEs supporting this feature. To support unchanged PCI after service link and/or feederlink switch due to movement of satelliteS, UE needs to know when to obtain the DL synchronization to new satellite and regain UL synchronization if needed, where UE is needed to be informed with timing such actions are performed. At least one of below options can be considered for this purpose:
Opt1: Explicit indication to enable unchanged PCI after satellite switch.
Opt2: A timing indication to indicate the satellite switch time.
Opt3: A relative time information to help calculate the satellite switch time

For option 1, in one example, the explicit indication is used together with legacy field t-service, where the t-service indicating the time current serving cell will stop provide service to current area. Upon reception of the explicit indication indicating the unchanged PCI is allowed, UE will start to perform necessary actions at the time indicate by t-service.

The necessary actions include at least one of below:
reacquiring the necessary system information (e.g., MIB, SIB1, SIB19 and etc.) from the new satellite;
monitoring SSB from the new satellite to obtain downlink synchronization;
obtaining uplink synchronization, e.g., by initiate RACH;
considering T430 as expired; and/or
considering timeAlignmentTimer as expired.

The explicit indication can be provide to UE by at least one of methods: broadcast signaling, system information, MAC CE, RRC messages, paging message, NAS message or group cast signaling.

For option 1, another example the usage of the explicit indication is to indicate when UE shall perform the necessary action as discussed above. For example, UE starts to reacquire the system information, perform DL/UL synchronization to new satellite at the time (e.g., slot, symbol) the indication is received. The explicit indication can be provided to UE by at least one of methods: broadcast signaling, system information, MAC CE, RRC messages, paging message, NAS message or group cast signaling.

For option 2, an explicit indication can be provided to indicate a timing when the switch will happen. In some examples, UE will perform at least one of the necessary actions discussed in above option 1 at the timing indicated by the time indication discussed here. In some examples, UE will perform at least one of the necessary actions discussed in above option 1 no later than or before the timing indicated by the time indication discussed here. The time indication can be delivered to UE based on at least one of methods discussed here: broadcast signaling, system information, MAC CE, RRC messages, paging message, NAS message or group cast signaling.

In an embodiment, a field t-Service-PCI-Unchanged in the SIB19 may indicate the time information on when a cell provided via NTN quasi-Earth fixed system is going to stop serving the area it is currently covering for PCI unchanged deployment. The field indicates a time in multiples of 10 ms after 00:00:00 on Gregorian calendar date 1 Jan. 1900 (midnight between Sunday, Dec. 31, 1899 and Monday, Jan. 1, 1900). The exact stop time is between the time indicated by the value of this field minus 1 and the time indicated by the value of this field. For option 3, a relative time information delta-time is provided. In one example, the relative time indicate the difference time between the time UE is expected to perform necessary actions as discussed in above examples, and the time indicated by t-service. E.g., UE determines the time to applied the necessary action by subtracting relative time from the time indicate by t-service; or UE determines the time to applied the necessary action by adding relative time from the time indicate by t-service. In some examples, UE will perform at least one of the necessary actions discussed in above option 1 no later than or before the timing calculated by the relative time indication discussed here. The relative time indication can be delivered to UE based on at least one of methods discussed here: broadcast signaling, system information, MAC CE, RRC messages, paging message, NAS message or group cast signaling.

In some examples, for above mentioned examples of option 1 option 2 and option 3, one or more offset values can be introduced to allow processing time at UE's side. For instance, when UE decides a first timing T and if UE is configured with one or more offsets (offset1, offset 2, and etc.,), then UE starts to reacquiring the system information, perform DL/UL synchronization to new satellite at a second timing T1 considering the offset received. One example could be T1=T+offset1+offset2+ . . . . In some example, the offset can be K-offset. The first timing T can be decided according to examples as discussed above for option 1-3, e.g., indicated by t-service, by receiving time of explicit indication, indicated by the timing indication discussed in option 2, or calculated based on the relative time information discussed in option 3.

During the switch, since there could be minor interruption, UE is not expected to transmits any uplink data before regain synchronization to target satellite. Also, UE needs to reacquire new SIB19 from target in order to obtain necessary assisting information for performing pre-compensation. Whether there is a need to perform RACH to fine-tuning TA may relevant to whether there is any uplink data arriving for transmission. i.e., UE triggers RACH when there is UL data arrival. While for arrival of DL data, it is possible for NW to use PDCCH order to trigger UE to perform RACH which is legacy behavior.

According to current specs, UE will stop UL transmission and flush HARQ, and reacquire SIB19 when T430 expires. Moreover, it shall be possible for UE to reuse existing triggering condition to trigger RACH, e.g., when TAT time expires but there is DL/UL data arriving. Therefore the simplest method to capture behaviors described in above observation in specs is to assume T430 and TAT timer as expired at the timing indicated by NW or calculated by UE. And the determination of the detailed timing can use at least one of examples discussed in above option 1 to option 3.

For unchanged PCI feature as discussed here, it raised new requirements to UEs. In some example, it is optional for UE to support this feature, an capability bit can be introduced to indicate whether UE support this feature. This capability can be request by and reported to NW through capability enquiry procedure as discussed in RACH-less HOs. Moreover, different NW nodes can change the received UE capability information through NW interface (e.g., Xn interface). In another example, this feature can be optional supported without capability signaling, where if receives such configuration UE simply ignores the configuration. Or in some example it is mandatory for UE to support this feature. Or in yet another example, it is conditional supported by UE, e.g., if UE supports NTN, UE supports PCI unchanged as discussed here.

Mobility management in wireless communication system can be assisted by neighboring cell measurements, based on measurement results received from UE, NW can adjust the criteria for cell (re) selection (e.g., adjust the cell and/or frequency priorities) and/or determine the target cells to be handover to and/or adjust the candidate target cells. However too many neighboring cell measurements will lead extra power consumption. A typical use case when UE is camped on NTN and been configured to measure on TN frequencies or vice versa. Due to movement of satellite, the coverage of TN with respect the coverage of NTN can shows up and disappears alternatively. Another further enhancements can be considered to relax the neighboring cell measurements on TN cells when there has no TN coverage available, therefore reduces the power consumption. To assist this behavior, information for UE to derive the TN coverage can be provided from NW. And at least below option can be considered for provide UE with the TN coverage information:
The TN coverage can be presented by a ellipse-shape area. Which can be presented at least one of below options:
Option 1: the TN coverage information can includes at least one of a coordinate of the ellipse center, a first length information, a second length information and an inclination information (e.g. an angle information).
For example, the first length is a half width (or length) (a) of the major axis of an ellipse centered at the origin, the second length information is a half width (or length) (b) the minor axis of an ellipse centered at the origin, the origin is a coordinate of the ellipse center associated to a geographical location. Based on the three information, an ellipse-shape area can be uniquely determined. An example equation is as below, assuming the ellipse centered at the origin:

$$\frac{{x}^{2}}{{a}^{2}} + \frac{{y}^{2}}{{b}^{2}} = 1$$

The inclination information (e.g. an angle information) can be provided to indicate the inclination of the ellipse with respect to a geographical area, in some example the inclination information may be referred as bearing angle. For example, a reference direction can be defined, e.g., it can be indicated as south, east, north or west. Then the angle information can be the angle between the ellipse major axis (can be the left-half or right-half of the ellipse major axis) and the reference direction. Or in another example the angle information can be the angle between the ellipse minor axis (can be the left-half or right-half of the ellipse major axis) and the reference direction. The angles can have a value range from zero to 360 degrees, which can be counted from 0 to 360 in a clockwise or counterclockwise method. In some examples the angle can be present with a step of x degrees, the x can be 1, or 2, or 5 or other integer that can be divisible by 360. In another example, the angles can have a value range from zero to 180 degrees, which can be counted from 0 to 180 in a clockwise or counterclockwise method. In some example the angle can be present with a step of x degrees, the x can be 1, or 2, or 5 or other integer that can be divisible by 180.

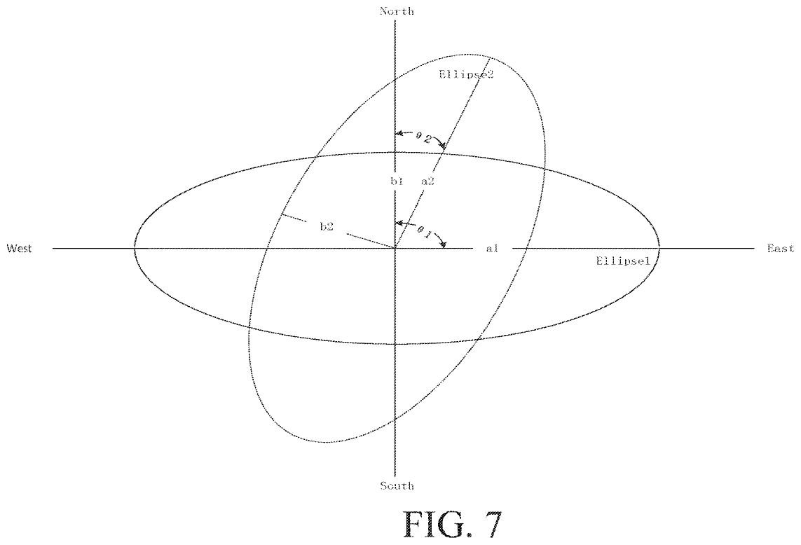

Below gives an example on how this angle information is presented and used (see FIG. 7). In this example, the reference direction is north, and the angle information indicates the angle between the ellipse major axis and the reference direction, which starts from 0 to 360 degrees in a clockwise method. For the two ellipse given, major axis is presented by ai(i=1,2), minor axis is presented by bi(i=1,2), and the angle between the ellipse major axis and the reference direction is θi(i=1,2), i is the index of each ellipse. If NW indicates the angle information equals to θ1, then TN coverage is the geographical area presented by Ellipse1.
Option 2: the ellipse can be presented by 5 points (e.g., a, b, h, k and the center of ellipse) assuming the center of ellipse as the origin, where the mathematical expression of the ellipse would be as below, assuming the ellipse centered at the (h, k):

$$\frac{{( x - h )}^{2}}{{a}^{2}} + \frac{{( y - k )}^{2}}{{b}^{2}} = 1$$

For option 2, one example is to provide UE with the actual coordinates of the 5 points (including the ellipse center), another example is to provide UE with the coordinates of the ellipse center, and the relative distance from the rest of points to the ellipse center.

In some example, the TN coverage (e.g. presented by an ellipse) can includes one or more TN cells, which can be up to NW implementation.

In some examples the provided TN coverage information is associated to frequency information. For example, for each TN coverage, one or more frequency information presented by a frequency list can be provided, which indicates the frequency can be measured within the TN coverage provided. In another example, the TN coverage is provided per frequency, e.g., a frequency is associated to one TN area. Or in another example the frequency information associated to TN coverage could be a bitmap, where the bitmap indicate the whether a frequency lists provided in system information (e.g., SIB3, SIB4, SIB19 or other SIBx) and/or in measurement objective is associated to the TN coverage or not. With each bit, value zero means the frequency is not considered associated to the TN coverage while value zero means the frequency is associated to the TN coverage, or vice versa. From Most significant bit (MSB) to least significant bit (LSB), the first bit of the bitmap correspondent to the first entry of the frequency list, second bit correspondent to second entry of the frequency list and so on.

In some example the TN coverage and/or associated frequency information can be provided to UE by at least one of the methods: Broadcast in system information (e.g., MIB, SIB1, SIB19, other SIBs specified in 3GPP standards or a new SIB), NAS message, Dedicated RRC signaling, common signaling for a group of UEs (e.g., groupcast, multicast).

In some example, if provided with the TN coverage, if UE camps on NTN cell, the UE may base on the TN coverage provided and its own location to decide whether there are available TN coverage, and UE can decide not to perform neighboring cell measurements on TN frequencies when there is no TN coverage.

Or in another example, if UE determine that it is approaching to an area that have TN coverage, UE may decide to prioritize the measurement on TN frequencies. In one example, a distance threshold can be introduced for NTN-TN cell reselection. If the distance between UE and the TN coverage center (e.g., could be ellipse or a circle or other geometrical shapes) is smaller than the threshold, UE prioritize the measurement on TN frequency. Or in another example two distance Thresholds can be introduced to assist the neighboring cell measurement. For example, if UE decides the distance between its location with NTN cell center is larger than a first distance threshold, and the distance between its location with TN coverage center is shorter than a second distance threshold, UE prioritize the measurement on the TN frequencies. Other measurement rules can be considered separately or in combination of the rules discussed here.

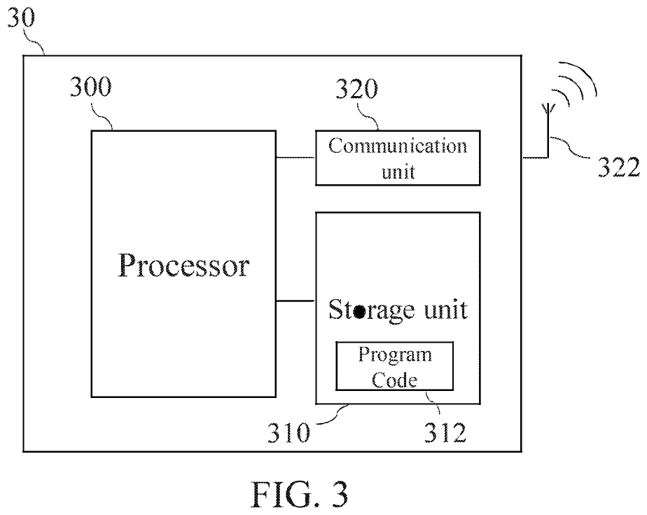

FIG. 3 relates to a schematic diagram of a wireless terminal 30 according to an embodiment of the present disclosure. The wireless terminal 30 may be a user equipment (UE), a mobile phone, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g. a base station).

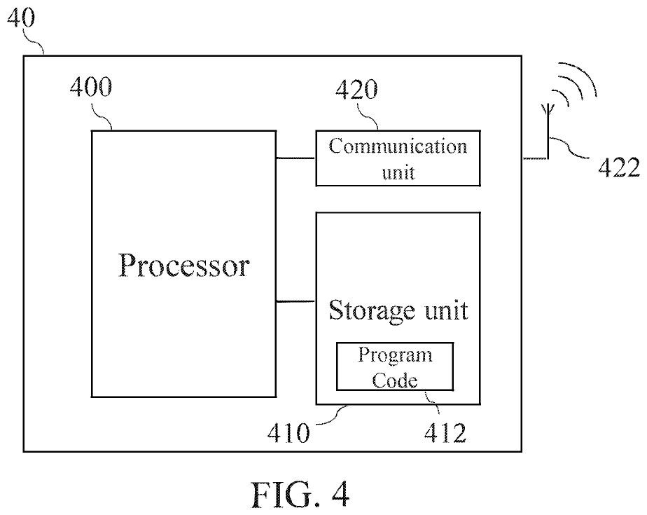

FIG. 4 relates to a schematic diagram of a wireless network node 40 according to an embodiment of the present disclosure. The wireless network node 40 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network, or a Radio Network Controller (RNC), and is not limited herein. In addition, the wireless network node 40 may comprise (perform) at least one network function such as an access and mobility management function (AMF), a session management function (SMF), a user place function (UPF), a policy control function (PCF), an application function (AF), etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g., a user equipment or another wireless network node).

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described above, but is not limited thereto.

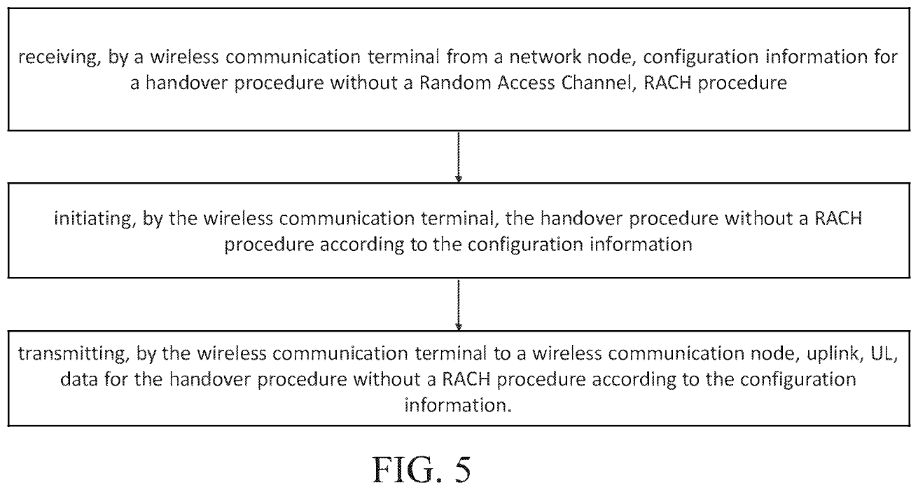

Referring to FIG. 5, in an embodiment, the wireless communication method includes: receiving, by a wireless communication terminal from a network node, configuration information for a handover procedure without a Random Access Channel, RACH procedure; initiating, by the wireless communication terminal, the handover procedure without a RACH procedure according to the configuration information; and transmitting, by the wireless communication terminal to a wireless communication node, uplink, UL, data for the handover procedure without a RACH procedure according to the configuration information.

In some embodiments, the configuration information can be the configuration for the RACH-less HO described above.

In some embodiments, the UL data can be the PUSCH using the UL resource scheduled by the NW described above.

In some embodiments, the UL data is transmitted on a UL resource according to the configuration information. In some embodiments, the UL resource comprises at least one of a pre-configured/pre-allocated UL resource described above or a dynamic scheduled resource described above.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a network node). In an embodiment, the wireless communication node may be implemented by using the wireless communication node 40 described above, but is not limited thereto.

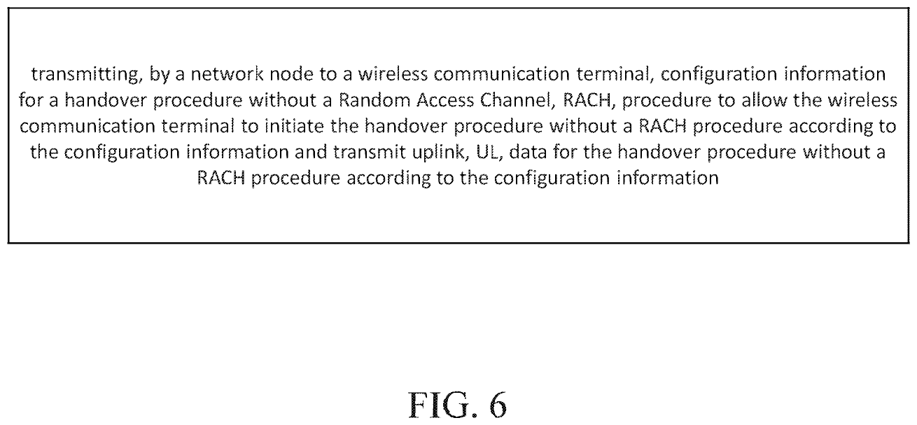

Referring to FIG. 6, in an embodiment, the wireless communication method includes transmitting, by a network node to a wireless communication terminal, configuration information for a handover procedure without a Random Access Channel, RACH, procedure to allow the wireless communication terminal to initiate the handover procedure without a RACH procedure according to the configuration information and transmit uplink, UL, data for the handover procedure without a RACH procedure according to the configuration information.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a wireless communication terminal from a network node, configuration information for a handover procedure without a Random Access Channel (RACH) procedure;
initiating, by the wireless communication terminal, the handover procedure without a RACH procedure; and
transmitting, by the wireless communication terminal to a wireless communication node, uplink (UL) data for the handover procedure without a RACH procedure.

2. The wireless communication method of claim 1, wherein the configuration information comprises at least one of:
Timing Advance (TA) information indicating a target TA to be applied to the wireless communication terminal;
a UL grant resource configuration for a pre-allocated UL resource for a transmission of the UL data;
a beam relevant configuration when the wireless communication terminal is scheduled by dynamic grant; or
power control relevant information for a transmission of the UL data.

3. The wireless communication method of claim 2, wherein the UL grant resource configuration comprises at least one of:
a code domain resource configuration;
a time domain resource configuration;
a frequency domain resource configuration;
antenna port information;
information indicating that whether a transform precoding is used;
a number of HARQ process numbers used for a Physical Uplink Shared Channel (PUSCH) transmission; or
beam information associated with a pre-allocated UL resource.

4. The wireless communication method of claim 3, wherein the beam information comprises at least one of:
a beam type;
a threshold for a beam selection for a PUSCH transmission;
a beam subset for beams to pre-allocated PUSCH mapping within one Configured Grant configuration, preferably indicated by a bitmap;
a number indicating the number of beams per pre-allocated PUSCH;
a number of demodulation reference signal (DMRS) sequences for beam to PUSCH mapping;
a set of DMRS ports for beam to PUSCH mapping.

5. The wireless communication method of claim 2, wherein the power control relevant information comprises at least one of:
a target power level for a transmission of the UL data;
an alpha value for a transmission power calculation of a transmission of the UL data, or
a P0 value for a transmission power calculation of a transmission of the UL data.

6. The wireless communication method of claim 5, further comprising:
if the wireless communication terminal transmits a PUSCH on an active uplink bandwidth (UL BWP) b of a carrier f of a serving cell c using a parameter set configuration with index j and the PUSCH power control adjustment state with index 1, determining, by the wireless communication terminal, a PUSCH transmission power as the target power level as:
$${P}_{PUSCH , b , f , c} ( i , j , {q}_{d} , l ) = min \{ \begin{matrix}{P}_{CMAX , f , c} ( i ) \\ {P}_{O\_PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ]$$
where
P_{CMAX,f,c}(i) is the wireless communication terminal configured maximum output power for carrier f of serving cell c in PUSCH transmission occasion i;
P_{O_PUSCH,b,f,c}(j) is a parameter composed of the sum of a component P_{O_NOMINAL,PUSCH,f,c}(j) and a component P_{O_UE_PUSCH,b,f,c}(j) where j∈{0, 1, . . . , J−1};
PL_{b,f,c}(q_{d}) is a downlink pathloss estimate in dB calculated by the wireless communication terminal using reference signal (RS) index q_{d} for the active DL BWP of carrier f of serving cell c;
$${M}_{RB , b , f , c}^{PUSCH} ( i )$$
is a bandwidth of the PUSCH resource assignment expressed in number of resource blocks for PUSCH transmission occasion i on active UL BWP b of carrier f of serving cell c and μ is a SCS configuration;
$${Δ}_{TF , b , f , c} ( i ) = 10 {log}_{10} ( ( {2}^{BPRE \cdot {K}_{s}} - 1 ) \cdot {β}_{offset}^{PUSCH} )$$
for Kₛ=1.25 and Δ_{TF,b,f,c}(i)=0 for Kₛ=0 where Kₛ is provided by deltaMCS for each UL BWP b of each carrier f and serving cell c; and
$${f}_{b , f , c} ( i , l ) = {f}_{b , f , c} ( i - {i}_{0} , l ) + {\sum }_{m = 0}^{C ( {D}_{i} ) - 1} {δ}_{PUSCH , b , f , c} ( m , l )$$
is the PUSCH power control adjustment state l for active UL BWP b of carrier f of serving cell c and PUSCH transmission occasion i if the wireless communication terminal is not provided tpc-Accumulation, or f_{b,f,c}(i, l)=δ_{PUSCH,b,f,c}(i, l) is the PUSCH power control adjustment state for active UL BWP b of carrier f of serving cell c and PUSCH transmission occasion i if the wireless communication terminal is provided tpc-Accumulation.

7. The wireless communication method of claim 6, wherein, if the wireless communication terminal uses a pre-allocated UL grant j=1, P_{O_NOMINAL,PUSCH,f,c}(1) is provided by the nominal power value, when the nominal power value is not provided, the wireless communication terminal assumes P_{O_NOMINAL,PUSCH,f,c}(1)=P_{O_NOMINAL,PUSCH,f,c}(0).

8. The wireless communication method of claim 6, wherein, if the wireless communication terminal uses a pre-allocated UL grant, j=1, P_{O_UE_PUSCH,b,f,c}(1) is provided by P0 obtained from the P0 value configured for the pre-allocated UL grant.

9. The wireless communication method of claim 5, wherein, if the wireless communication terminal uses a pre-allocated UL grant and uses the alpha value, for α_{b,f,c}(j) and j=1, α_{b,f,c}(1) is provided by alpha obtained from the alpha value configured to the pre-allocated UL grant.

10. The wireless communication method of claim 1, wherein the wireless communication terminal performs at least one of:
determining a UL resource among candidate UL resources which are pre-allocated or dynamically scheduled to transmit the UL data; or
determining a beam to transmit the UL data.

11. The wireless communication method of claim 2, wherein, when the wireless communication terminal is scheduled by dynamic grant, the beam relevant configuration comprises at least one of an SSB index or a transmission configuration indication (TCI) state configuration.

12. The wireless communication method of claim 10, wherein, if the UL resources are pre-allocated, the wireless communication terminal performs at least one of:
selecting a beam satisfying following condition as the beam to transmit the UL data:
the beam is associated with a Synchronization Signal/Physical Broadcast Channel Block (SSB) with a reference signal received power (RSRP) higher than a first configured threshold; or
performing a fallback to a handover procedure with a RACH procedure in response to there is no beam associated with an SSB with a RSRP higher than a first configured threshold.

13. The wireless communication method of claim 10, wherein the wireless communication terminal performs at least one of following operations to determine the UL resource:
selecting a first available UL resource as a first available configured grant (CG) resource based on a CG configuration in response to the candidate UL resources are a subset or a complete set of CG resources; or
monitoring a PDCCH using a cell radio network temporary identifier (C-RNTI) and taking a UL resource scheduled by the PDCCH as the UL resource to transmit the UL data.

14. The wireless communication method of claim 1, wherein the wireless communication terminal transmits a capability for supporting a handover procedure with a RACH procedure being skipped,
preferably wherein the handover procedure is a normal handover or a conditional handover.

15. The wireless communication method of claim 1, wherein, if the handover procedure is successfully completed, the terminal performs at least one of stopping a T304 timer or releasing the configuration for the handover procedure.

16. A wireless communication terminal, comprising:
a communication unit; and
at least one processor configured to:
receive, via the communication unit from a network node, configuration information for a handover procedure without a Random Access Channel (RACH) procedure;
initiate the handover procedure without a RACH procedure; and
transmit, via the communication unit to a wireless communication node, uplink (UL) data for the handover procedure without a RACH procedure.

17. A computer program product comprising a non-transitory computer-readable program medium with code stored thereupon, the code, when executed by at least one processor, causes the at least one processor to:
receive, via a communication unit from a network node, configuration information for a handover procedure without a Random Access Channel (RACH) procedure;
initiate the handover procedure without a RACH procedure; and
transmit, via the communication unit to a wireless communication node, uplink (UL) data for the handover procedure without a RACH procedure.
